(19) United States
(12) Patent Application Publication
(10) Pub. No.: US 2007/0294392 A1
(43) Pub. Date: Dec. 20, 2007

(54) APPARATUS, SYSTEM, AND METHOD FOR INTELLIGENT POLLING SUPPORT FOR WEBSPHERE ADAPTERS BASED ON THE SELF-CONFIGURATION CHARACTERISTIC OF AN AUTONOMIC COMPUTING MODEL

(75) Inventors: Gopalakrishnan Balasubramanian, Sunnyvale, CA (US); Rajan Kumar, Rajapalayam (IN)

Correspondence Address: Kunzler & McKenzie, 8 EAST BROADWAY, SUITE 600, SALT LAKE CITY, UT, 84111, US

(73) Assignee: INTERNATIONAL BUSINESS MACHINES CORPORATION, ARMONK, NY (US)

(21) Appl. No.: 11/425,362

(22) Filed: Jun. 20, 2006

(51) Int. Cl. G06F 15/173

(52) U.S. Cl. 709/224

(57) ABSTRACT

An apparatus, system, and method are disclosed for intelligent polling support for Websphere JCA adapters based on the self-configuration characteristic of an autonomic computing model. The apparatus, system, and method maintain a set of statistical parameters across multiple poll cycles that are used to adjust polling parameters. The polling parameters control poll intervals and poll quantities. The polling parameters are adjusted based on historical event arrival rates.

### BACKGROUND OF THE INVENTION

1. Field of the Invention

This invention relates to polling frequencies for JCA WebSphere adapters and more particularly relates to self-configuration of polling characteristics of JCA WebSphere adapters.

2. Description of the Related Art

An IBM JCA WebSphere Adapter implements the Java 2 Enterprise Edition (J2EE) Connector architecture (JCA), version 1.5. JCA is a standard architecture for integrating J2EE applications with enterprise information systems. Also known as resource adapters or JCA adapters, WebSphere Adapters enable managed, bidirectional connectivity between enterprise information systems (EISs) and J2EE components supported by WebSphere Process Server.

In many cases, the EISs do not contact WebSphere to report pending messages also called events. Consequently, in order to insure prompt bi-directional connectivity and data flow, the JCA adapter polls associated EISs to determine if messages and/or business objects from the EIS are available for retrieval. JCA adapters are configured to poll for a determined number of events at determined intervals. Some EISs limit the number of events for which a JCA adapter may poll during one poll cycle. Consequently, to insure efficient utilization of the link between the JCA adapter and the EIS and to limit the latency of business objects ready for transmission, the selection and determination of polling quantities and polling intervals can greatly affect the efficiency of business object transmission from an EIS across a JCA adapter.

Unfortunately, not all system administrators are versed in proper selection of poll quantities and poll frequencies. Also, as network and EIS circumstances change, the poll quantities and poll frequencies may require adjustment.

From the foregoing discussion, it should be apparent that a need exists for an apparatus, system, and method that dynamically select and modify the poll quantity and the poll interval associated with a JCA adapter. Beneficially, such an apparatus, system, and method would reduce latency of transmitted business objects are prevent a system administrator from needing to learn how to adjust poll quantities and poll frequencies or to perform the adjustment.

### SUMMARY OF THE INVENTION

The present invention has been developed in response to the present state of the art, and in particular, in response to the problems and needs in the art that have not yet been fully solved by currently available apparatuses, systems, and methods for intelligent polling support for Websphere adapters based on the self-configuration characteristic of an autonomic computing model. Accordingly, the present invention has been developed to provide an apparatus, system, and method for intelligent polling support for Websphere adapters based on the self-configuration characteristic of an autonomic computing model that overcome many or all of the above-discussed shortcomings in the art.

The apparatus to accomplish intelligent polling support for Websphere adapters based on the self-configuration characteristic of an autonomic computing model is provided with a plurality of modules configured to functionally execute the necessary steps to accomplish intelligent polling support for Websphere adapters based on the self-configuration characteristic of autonomic computing model. These modules in the described embodiments include an initialization module, a timing module, a polling module, a statistical module, and an adjustment module.

The apparatus, in one embodiment, is a computer program product comprising a computer useable medium including a computer readable program, the computer program product when executed on a computer causes the computer to initialize a set of polling parameters based on user-defined values, the set of polling parameters comprising a poll quantity, a poll interval, and a poll group count. The computer further executes a plurality of poll groups comprising a set of poll cycles, each poll cycle comprising: polling an enterprise information system (EIS) for a number of events satisfying the poll quantity parameter, timing the processing of the events of the poll cycle, and counting the events processed in the poll cycle. The computer further determines an average cycle processing time based on the event processing times for each poll cycle in the poll group. The computer further determines an average number of cycle events processed based on a count of events processed in each poll cycle of the poll group. The computer further adjusts the polling parameters based on the average cycle processing time of the poll group and the average number of cycle events processed of the poll group such that polling parameters correspond to EIS event rates.

In one embodiment of the computer program product, the poll quantity determines the number of events to poll during each poll cycle; the poll interval determines the time between poll cycles; and the poll group count determines the number of poll cycles in each poll group.

An apparatus of the present invention is also presented. The apparatus comprises an initialization module configured to initialize a pollInterval parameter, a pollQuantity parameter, a pollGroupSize parameter, a maxPollInterval parameter, a minPollQuantity parameter, a pollQuantityIncrement, and a maxIteration parameter; a timing module configured to calculate time characteristics of successive poll cycles; a polling module configured to execute a poll cycle comprising the polling of an enterprise information system (EIS) for the occurrence of a select set of events wherein the select set of events has a quantity equal to the pollQuantity parameter; a statistical module configured to update an avgEventsPolled parameter, an avgTimeTaken parameter, a cumAvgEventsPolled parameter, and a cumAvgTimeTaken parameter based on the time characteristics recorded by the timing module; an adjustment module configured to update the pollInterval parameter and the pollQuantity parameter based on the time characteristics of prior poll cycles, wherein the polling module polls the EIS at an interval equal to the value of the pollInterval, and wherein the statistical module determines the average number of events polled per poll.

The apparatus, in a further embodiment, is further configured to increase the pollQuantity in response to a determination by the statistical module that the average number of events polled equals the pollQuantity.

The apparatus, in a further embodiment, is further configured to decrease the pollQuantity in response to a determination by the statistical module that the average number of events polled is less than the pollQuantity.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system in accordance with the present invention;

FIG. 2 is a schematic block diagram illustrating one embodiment of a JCA Websphere adapter in accordance with the present invention; and

FIG. 3 is a schematic flow chart diagram illustrating one embodiment of a method in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer program of a computer useable medium and useable by a computer as part of a computer program product program may take any form capable of generating a signal, causing a signal to be generated, or causing execution of a program of machine-readable instructions on a digital processing apparatus. A computer readable medium may be embodied by random access memory, read only memory, flash memory, a transmission line, a compact disk, digital-video disk, a magnetic tape, a Bernoulli drive, a magnetic disk, a punch card, integrated circuits, custom VLSI circuits, gate arrays, or other digital processing apparatus memory devices or other devices capable of directing, modifying, or otherwise providing input to the processing of a digital processing apparatus.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

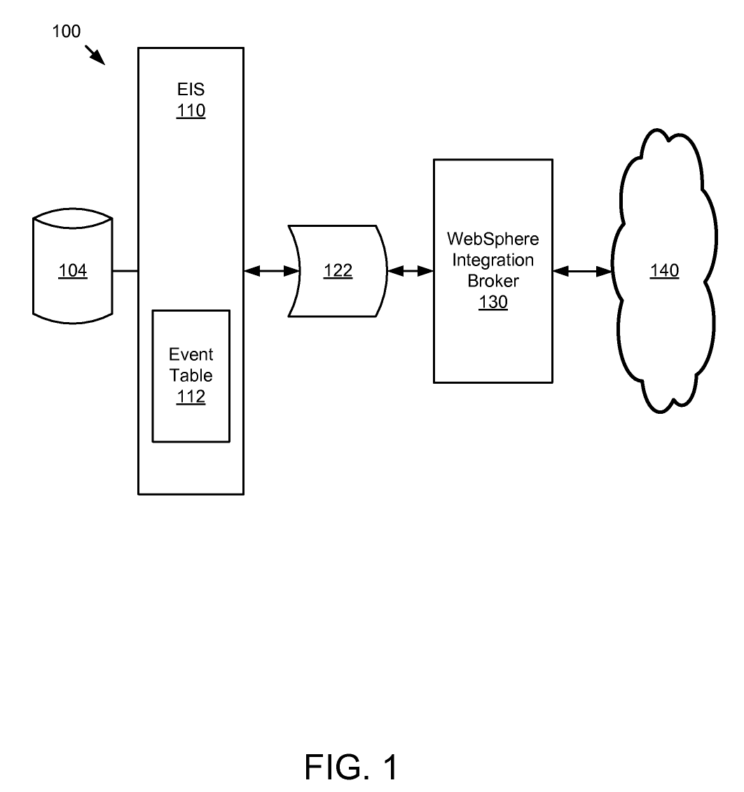

FIG. 1 depicts a system 100 that provides intelligent polling support for Websphere adapters based on self-configuration characteristics of an autonomic computing model. The system 100 is designed to facilitate efficient flow of data and/or business objects from one EIS (Enterprise Information System) 110 across a WebSphere integration broker 130 to devices and/or components in a network 140. A JCA adapter 122 facilitates communication between the EIS 110 and the integration broker 130.

An autonomic computing model attempts to dynamically adjust configurable parameters in a computing system. The autonomic computing model recognizes that many computing systems comprise an unmanageable number of configurable parameters. For the most part, these parameters may be set one time, or alternatively, they may be modified according to a computer manageable process. The autonomic computing model tries to identify those parameters that the computer system may set without the intervention of the system administrator and user. In this fashion, the complexity of computer configuration is reduced, configuration errors are reduced, and the computing system becomes adaptable to changed circumstances.

Traditional adapters (not shown) are designed and developed to exchange data between Enterprise Information Systems (EISs) and/or databases using a static polling mechanism. Static polling is often inefficient. Static polling restricts the poll interval (time period between two poll cycles) and quantity (number of events to be polled during a poll cycle) from being dynamically adjusted at run-time. As a result, traditional adapters poll at a pre-set interval and try to fetch a pre-set quantity, irrespective of an increase/decrease in the number of events in the database/EIS.

The EIS (enterprise information system) 110 may provide database services legacy business processing services, or the like to a business, corporation, institution, or other group. The EIS 110 may comprise a database 104 or alternatively, may connect to a separate database 104. The EIS 110 may further comprise an event table 112. The event table 112 tracks new database records and/or business objects ready from transmission from the EIS 110 to the integration broker 130. The adapter 122 polls the EIS 110 to determine if new events exist in the event table 112. Each poll of the event table 112 by the adapter 122 is termed a poll cycle. A poll requests a specific number of events from the event table 112. The number of events polled during one poll cycle is termed the poll quantity or pollQuantity. The adapter 122 may poll for a number of events, where the number is equal to the pollQuantity. If there are more events in the event table 112 than the pollQuantity amount, the EIS 110 returns no more than pollQuantity events. Some EISs 110 limit the maximum pollQuantity value to a small number, for example two hundred.

The adapter 122 waits a pre-set interval equal to pollInterval seconds between each poll. PollInterval is a configurable parameter that equals the number of seconds between poll cycles. Waiting allows the more efficient use of the link, preventing continuous polling that would waste link bandwidth.

The adapter 122 modifies the pollInterval value and the pollQuantity value dynamically. Typically, the adapter 122 records average access times for a series of poll cycles and adjusts the pollInterval and the pollQuantity as needed after a determined number of poll cycles. The series of poll cycles over which pollInterval and pollQuantity are held constant is termed a poll group. The pollInterval and the pollQuantity may be dynamically modified by the adapter 122 following each poll group.

The adapter 122 tracks the parameters listed above as well as several others. The parameters tracked by the adapter 122 along with their meanings are listed below:

| | |
|---|---|
| pollInterval: | Time interval between two consecutive poll |
| | cycles in seconds. |
| pollQuanity: | Maximum number of events to be fetched |
| | per poll cycle. |
| pollGroupSize: | Number of poll cycles per poll group. |
| maxPollInterval: | Threshold value for pollInterval. |
| minPollQuantity: | Threshold value for poll quantity. |
| pollQuantityIncrement: | Used to increment pollQuantity. For |
| | example, if the pollQuantity and the actual |
| | number of events polled are both 100, the |
| | pollQuantity will be incremented by 5, i.e. |
| | 100 + 5 = 105. This will be done every time |
| | the two values match. |
| maxIteration: | Maximum number of pollGroups for which |
| | the metrics collected will be maintained. For |
| | example, if maxIteration equals 300, after |
| | 300 poll groups, the adapter 122 will start |
| | discarding the oldest poll group value for |
| | every latest one done beyond 300, e.g. poll |
| | group 1 will be discarded when 301 is done. |
| timeTaken: | Actual time duration taken for the events |
| | polled during a poll Cycle |
| eventsPolled: | Actual number of events polled during a poll |
| | cycle. This should be less than or equal to |
| | the pollQuantity. |

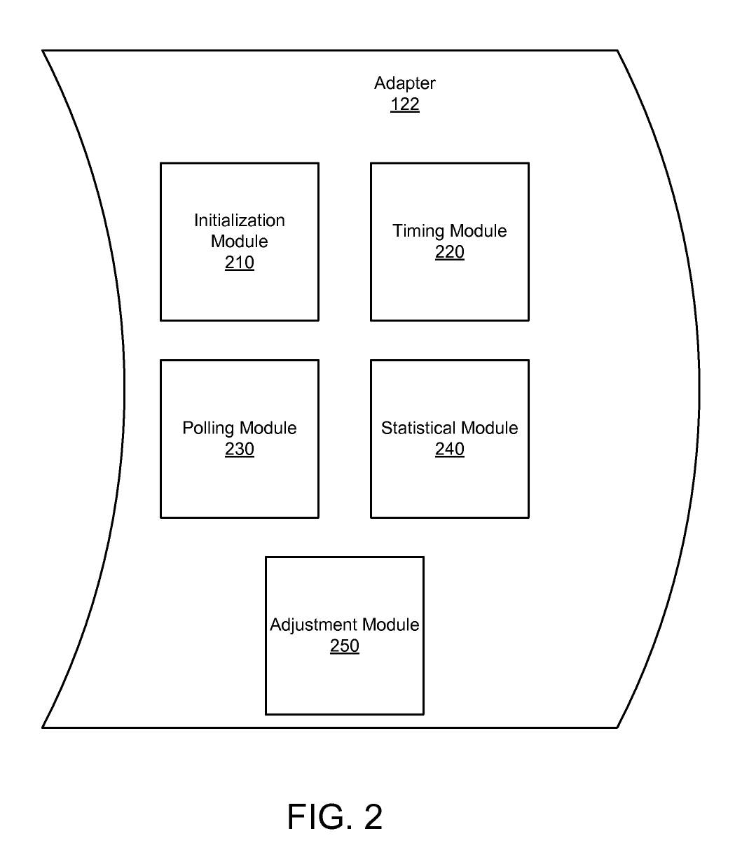

FIG. 2 depicts one embodiment of an adapter 122 consistent with the present invention. The adapter 122 may comprise an initialization module 210, a timing module 220, a polling module 230, a statistical module 240, and an adjustment module 250.

The initialization module 210 handles initialization of several parameters including pollInterval, pollQuantity, pollGroupSize, maxPollInterval, minPollQuantity, pollQuantityIncrement, and maxIteration. The initialization module 210 further initializes arrays, queues, and other data structures used to store statistical data. The parameters may be initialized to preset values or to user configurable values. In one embodiment, the module 210 comprises various arrays and queues including arrayEventsPolled, arrayTimeTaken, queueAvgTimeTaken and queueAvgEventsPolled. The arrayEventsPolled array comprises a series of cells to store the number of events polled in successive poll cycles. The arrayTimeTaken array comprises a series of cells to store the time required to complete successive poll cycles. The queue queueAvgEventsPolled stores the average number events polled in successive poll groups. The queue queueAvgTimeTaken stores the average time taken for polling in successive poll groups. The queues and arrays described could be implemented as queues, arrays, lists, or other data structures known to those of skill in the art. The arrays and queues may be owned by the initialization module 210, by the adapter 122, or by another module of the adapter 122.

The timing module 220 records timing measurements for the start and completion of poll cycles. The polling module 230 executes polls of the EIS 110. The statistical module 240 tracks all of the statistical information and calculates intermediate and final values. The adjustment module 250 uses the statistical information recorded and created by the statistical module 240 to determine how to adjust polling intervals and polling quantities.

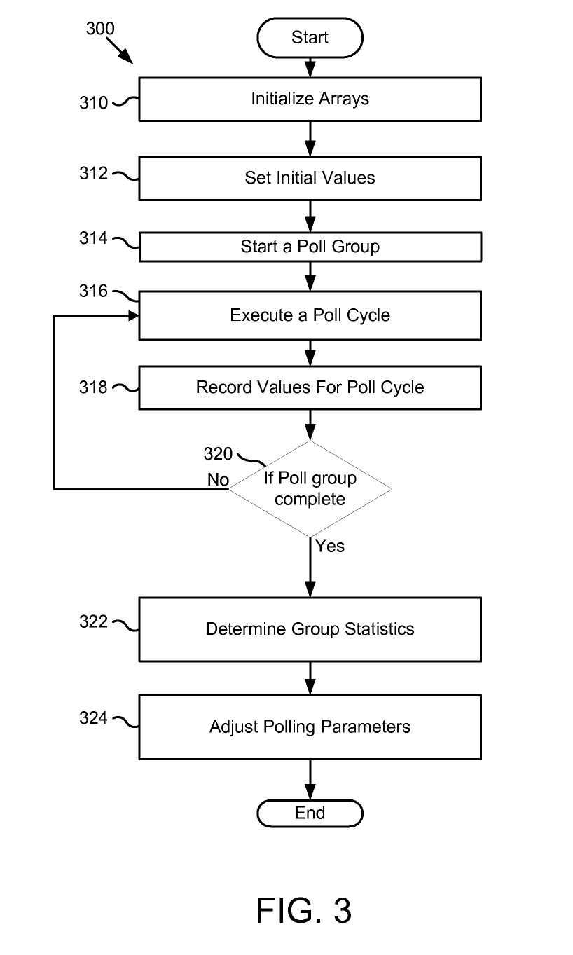

FIG. 3 depicts a method 300 for intelligent polling support for Websphere JCA adapters 122 based on the self-configuration characteristic of an autonomic computing model. The method 300 comprises initializing 310 arrays and queues, setting 312 initial parameter values, starting 314 a poll group, executing 316 a series of poll cycles, recording 318 parameter values for the most recent poll cycle, determining 320 whether the poll group is complete, determining 322 group statistics for the poll group, and adjusting 324 polling parameters based on the recorded poll cycle values.

The adapter 122 tracks various values in arrays, queues, lists, or other data structures during the course of each poll cycle and each poll group. The adapter 122 uses the array values to track polling parameters and to determine how to adjust the polling parameters. In one array, the adapter 122 tracks the time taken to complete the polling for each poll cycle in a poll group. The array has as many slots as there are poll cycles in a poll group. The adapter 122 uses another array of equal length to record the number of events polled in a given poll cycle. The adapter 122 initializes 310 the arrays when the adapter is created and then reuses the oldest cell in each array as each previous poll cycle completes.

The initialization module 210 further initializes 310 two more arrays: an average time taken array and an average events polled array. These arrays trace the average time for a single poll cycle across a large number of poll groups and the average number of events actually polled over a large number of poll groups.

The initialization module 210 further sets 312 initial values for pollInterval, pollQuantity, pollGroupSize, maxPollInterval, minPollQuantity, pollQuanitityIncrement, and maxIteration whose definitions follow:

| | |
|---|---|
| pollQuantity: | Number of events requested in each poll |
| | cycle. |
| pollGroupSize: | Number of poll cycles in one poll group. |
| maxPollInterval: | Maximum time that the polling module 230 |
| | waits between poll cycles. |
| minPollQuantity: | Minimum number of events that the polling |
| | module 230 requests in a single poll cycle. |
| pollQuantityIncrement: | Amount by which the adjustment module |
| | 250 increases the pollQuanitity following a |
| | poll group in which the average number of |
| | events polled equals the pollQuantity. |
| maxIteration: | Number of historical poll groups by which |
| | the adjustment module 250 maintains |
| | statistics. |

The initial values for each of these parameters may be determined at compile time by a developer or may be configured by a system administrator. In either case, the adjustment module 250 may adjust the parameters dynamically without the need of operator intervention.

The method 300 further comprises starting 314 the execution of a poll group. A poll group comprises executing 316 a series of poll cycles. For each poll cycle, the polling module 122 polls the EIS 110 for a specific number of events. The number of events requested equals pollQuantity. The adapter 122 may receive business objects and/or data from EIS 110 for each polled event. The timing module 220 records 318 the values for the various parameters for each poll cycle and insures that the polling module 330 executes its polling function in accordance with the pollQuantity and pollInterval parameters. The statistical module 240 may record the quantityPolled (the number of events requested), the actual eventsPolled (the number of events polled in a single poll cycle) and the timeTaken (the time required to complete the poll cycle).

At the end of each poll cycle, the polling module 230 determines 320 if the poll group is complete. If the poll group is not complete, the adapter 122 continues to execute 316 the next poll cycle. Otherwise, the polling module 230 adjusts the parameters according to the recorded measurements.

At the end of the poll group, the statistical module 240 determines 322 poll group statistics including avgTimeTaken, avgEventsPolled, cumAvgTimeTaken and cumAvgEventsPolled. The avgTimeTaken variable contains the average time taken to execute the polled events for the just completed poll cycle. The avgEventsPolled variable contains the average number of events polled for the just completed poll cycle. The cumAvgTimeTaken averages the average time taken for a group of poll groups. The queueAvgTimeTaken is an array of length MaxIterations. As each poll group is completed, the avgTimeTaken for the last poll group is stored in a modulus fashion in the queueAvgTimeTaken array. Using the values from this array, the statistical module 240 generates a value equal to the average of all of the last maxIterations groups and stores this in cumAverageTimeTaken. Similarly, the statistical module 240 generates a value equal to the average of the avgEventsPolled over the last maxIterations and stores this average in cumAvgEventsPolled.

Using the determined statistics, the adapter adjusts 324 the pollQuantity and pollInterval parameters. If the avgEventsPolled equals the pollQuantity value, then the adapter 122 increases the pollQuantity by the pollQuantityIncement value. This insures that the link between the adapter and the EIS is not under utilized.

If the avgEventsPolled is less than the pollQuantity, then more events are being polled than are available. When this occurs, the adjustment module 250 reduces the pollQuantity to the maximum of the minPollQuantity and the cumAvgEventsPolled. Additionally, the adjustment module 250 sets the pollInterval to the minimum of the maxPollInterval and the cumAvgTimeTaken. These adjustments reduce the polling interval and the number of events polled, to more efficiently use the link.

The effect of the poll parameter adjustments creates a concrete and tangible result—the link between the adapter 122 and the integration broker 130 is more efficiently utilized. In addition, the transmission of data and business objects is more efficient.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An integration broker adapter program product for automatically adjusting polling characteristics comprising a computer useable medium including a computer readable program, the integration broker adapter program product when executed on a computer causes the computer to:
initialize a set of polling parameters based on user-defined values, the set of polling parameters comprising a poll quantity, a poll interval, and a poll group count;
execute a plurality of poll groups comprising a set of poll cycles, each poll cycle comprising:
polling an enterprise information system (EIS) for a number of events satisfying the poll quantity parameter,
timing the processing of the events of the poll cycle, and
counting the events processed in the poll cycle;
determine an average cycle processing time based on the event processing times for each poll cycle in the poll group;
determine an average number of cycle events processed based on a count of events processed in each poll cycle of the poll group;
adjust the polling parameters based on the average cycle processing time of the poll group and the average number of cycle events processed of the poll group such that polling parameters correspond to EIS event rates.

2. The program product of claim 1, wherein:
the poll quantity determines the number of events to poll during each poll cycle;
the poll interval defines the time between poll cycles; and
the poll group count defines the number of poll cycles in each poll group.

3. The program product of claim 1, wherein adjusting the polling parameters further comprises increasing the poll quantity at the end of a poll group in response to determining that the average events polled during each poll cycle of the poll group is equal to the poll quantity and decreasing the poll quantity to equal the average number of events polled at the end of the poll group in response to determining that the average number of events polled is less than the poll quantity.

4. An JCA (Java 2 Enterprise Edition Connector Architecture) adapter to automatically adjust polling characteristics based on historical polling feedback, the adapter comprising:
an initialization module configured to initialize a pollInterval parameter, a pollQuantity parameter, a pollGroupSize parameter, a maxPollInterval parameter, a minPollQuantity parameter, a pollQuantityIncrement, and a maxIteration parameter;
a timing module configured to calculate time characteristics of successive poll cycles;
a polling module configured to execute a poll cycle comprising the polling of an enterprise information system (EIS) for the occurrence of a select set of events wherein the select set of events has a quantity equal to the pollQuantity parameter;
a statistical module configured to update an avgEventsPolled parameter, an avgTimeTaken parameter, a cumAvgEventsPolled parameter, and a cumAvgTimeTaken parameter based on the time characteristics recorded by the timing module;
an adjustment module configured to update the pollInterval parameter and the pollQuantity parameter based on the time characteristics of prior poll cycles,
wherein the polling module polls the EIS at an interval equal to the value of the pollInterval, and
wherein the statistical module determines the average number of events polled per poll

5. The adapter of claim 4, wherein the adjustment module is further configured to increase the pollQuantity in response to a determination by the statistical module that the average number of events polled equals the pollQuantity.

6. The adapter of claim 5, wherein the adjustment module is further configured to decrease the pollQuanity in response to a determination by the statistical module that the average number of events polled is less than the pollQuantity.
